(19) United States
(12) Patent Application Publication
(10) Pub. No.: US 2006/0010402 A1
(43) Pub. Date: Jan. 12, 2006

(54) Graphical user interface navigation method and apparatus

(76) Inventor: Renaldo V. Undasan, West Ewell (GB)

Correspondence Address: PHILIPS INTELLECTUAL PROPERTY & STANDARDS, P.O. BOX 3001, BRIARCLIFF MANOR, NY, 10510, US

(21) Appl. No.: 10/528,676

(22) PCT Filed: Sep. 5, 2003
(86) PCT No.: PCT/IB03/03907

§ 371 Date: Mar. 21, 2005

(30) Foreign Application Priority Data
Sep. 24, 2002 (GB) 0222094.5

(51) Int. Cl. G06F 3/00

(52) U.S. Cl. 715/861; 715/865

(57) ABSTRACT

A method for translating an object within a GUI display. Another object, such as a cursor, is positioned (104) so as to be co-located (106) with the object; the object and cursor are then translated (110) along a path at least partially determined (108) by data associated with the cursor. Translation along the path ceases (114) when the relative position of the cursor and object changes (112); translation may continue along a different path if the cursor and object remain co-located. An example embodiment is a cursor icon which allows a user, by manipulating a pointing device, to navigate an entire GUI display area by navigating the smaller area of the cursor icon.

The present invention relates to graphical user interfaces for computers and the like, and in particular to an improved method and apparatus for use with pointing or similar devices.

The graphical user interface (GUI) technique has become very popular as a means for users to interact with and control software applications running on a whole variety of computer systems and software based devices. An operation common to many GUIs involves the indication and subsequent selection and/or movement of an object rendered on the GUI display. User input means to achieve this include mouse, trackball, touchpad, etc. A known problem is that users and operators may suffer hand and wrist discomfort associated with the frequent and repetitive operation of such input devices; in some cases the user is diagnosed as suffering from one or more recognised disorders belonging to the generic medical condition known as Repetitive Strain Injury (hereinafter referred to as RSI).

Various techniques have been devised to help reduce the likelihood of RSI in users of GUI input means, particularly in relation to use of the desktop mouse. International application WO 01/16688 A1 published 8^{th} Mar. 2001 discloses a software product to enhance or augment an operating system and/or software application to recognise traditional objects and convert them. A traditional object that is activated by clicking on the pointing device may be converted to an object which responds to a specific dynamic cursor interaction, such as a cursor movement pattern. A disadvantage of this method is that a user has to learn one or more specific dynamic cursor interactions associated with an object. A further disadvantage is that, whilst providing an alternative to clicking of a pointing device, the user is still required to accurately position the cursor to be over an object in the GUI display and also perform additional specific dynamic cursor interactions. International application WO98/44406 assigned to the present applicant discloses a compound cursor arrangement for use in a GUI of a computer system. The compound cursor comprises an active cursor which acts in conventional manner and a passive cursor which follows the active cursor around the display. The function of the passive cursor is to drag icons selected by the active cursor. A disadvantage of this method is that the active cursor still requires the positional and other manipulations that are associated with conventional cursor operation, such as might be performed by a user using a mouse.

It may be a legal requirement, or at least public policy, of many states that every class of user is able to operate a product. In the pursuit of including increased amount of content on the display, present day GUI designs may disadvantage those users less able to accurately control pointing devices such as a mouse; in particular those users with motor impairments of the arm/hand or problems with hand-eye co-ordination may find it difficult to position or manipulate the cursor with sufficient precision in relation to an object on the GUI display. A presumption of some pointing devices is that a user is sufficiently dextrous to manipulate the pointing device to move and position the cursor anywhere within the GUI display area and with sufficient accuracy.

It is an object of the present invention to solve these and other problems by providing an improved method for moving a GUI object, by a process of translation, to enable a user to interact with and control software applications in conjunction with a pointing device and a GUI display.

In accordance with the present invention there is provided a method of translating an object within a GUI display, the display comprising a first object and a second object, the method comprising the steps of:
a) positioning the first object relative to the second object, such that a first pre-defined coordinate position associated with the first object is substantially co-located with a second pre-defined coordinate position associated with the second object:
b) determining a path for translation;
c) translating the first object and the second object according to the determined path, such that the first object remains substantially co-located with the second object during the translation;
d) repositioning the first object relative to the second object; and
e) ceasing the translation.

Many GUI-based computer applications require the movement and/or positioning of objects within a GUI display, examples include, but are not limited to, drag and drop, drawing lines and shapes, etc. The present invention enables an object to be moved around a GUI display by means of translation, that is movement along a linear path within the GUI display. In prior art methods, a user is required to trace the path of the translation by for example using a pointing device. In the method of the present invention a first object is positioned to be substantially co-located with a second object. Information related to translation is then acquired and used to determine a path along which to translate the objects. Translation then occurs wherein the first and second objects are translated together along the determined path thereby remaining substantially co-located. Subsequently, where the system detects a repositioning of the first object relative to the second object, translation (at least along the present path) may stop. The method is suitable for use with any type of moveable object. One advantage of the method is a reduction in risk of RSI in that a user is not required to manually track the translation path when translating (moving) an object; the method does not require user manipulation of for example a pointing device during the translation of an object. A further advantage is that translation is performed along an accurate linear path or trajectory. This can be beneficial in applications which require accurate or steady hand operation including, but not limited to, freehand drawing and computer aided design (CAD). An associated benefit is that such applications may be made accessible to those users with unsteady hands or similar motor skills impairment.

The second object (the object to be translated) may have associated with it one or more pre-defined co-ordinate positions. Preferably, these pre-defined co-ordinate positions comprise a boundary associated with the object. The boundary may encompass a context sensitive area of an object including, but not limited to, an object residing within a computer application. The first object may also have associated with it one or more pre-defined co-ordinate positions. Preferably, the first object has one pre-defined co-ordinate position. When the first object is positioned relative to the second object, co-location of the first and second objects may be determined by the substantial co-location of a pre-defined co-ordinate position of the first object with one of the pre-defined co-ordinate positions of the second object. The second object may be one of a number of objects, which objects are associated such that they may be translated as a single object.

The first object may comprise data which can, at least partially, be used to determine the path for translation. One example might be data which indicates a bearing. The second object may be translated along a path which includes a reference co-ordinate of the second object and in a direction according to the indicated bearing. A suitable reference co-ordinate of the second object might be its origin co-ordinate in relation to the GUI display; a preferred reference co-ordinate of the second object is its origin as defined in accordance with the Windows® GUI. The first object may indicate the bearing as a data value; the first object may alternatively comprise an orientatable graphical symbol, the orientation of which could be used to determine the path for translation. An example might be where the first object comprises a cursor symbol such as an arrow; the path for translation might be determined by the orientation of the symbol with respect to the axes of the GUI display, the direction of translation being in accordance with the direction of the arrow.

When the first and second objects are co-located, the path for translation may be determined using the bearing method described above. Alternatively, when co-located, the position of the first object relative to the second object may be used to determine the path for translation. One example is where the path is determined to be along a line comprising a suitable reference co-ordinate of the second object and the pre-defined co-ordinate position associated with the second object at the co-location position. A suitable reference co-ordinate of the second object might be the origin as defined in accordance with the Windows® GUI. The path may be partly determined by a pre-defined rule; for example, the path is determined to proceed in the direction from the second pre-defined coordinate position to the reference co-ordinate (such that the first object might be viewed as ‘pushing’ the second object along the translation path).

Once the path for translation has been determined, translation of both first and second objects may occur such that the two objects remain substantially co-located during the translation. Translation, at least along the present path, may cease when the position of the first object changes relative to the second object. Where the objects are still co-located the translation may continue along a new path as determined by the methods described earlier; otherwise in the case where the objects are no longer co-located the translation may cease.

The method of the invention may be used in conjunction with existing computer program applications and/or user operating means. It may be implemented for example, but not limited to, by means of a plug-in or a suitable device driver. One example of an implementation is an alternative method of drag and drop operation using a conventional mouse. A user might position an on-screen cursor to be co-located with an object. The object is then translated (in this example, dragged) along a path (at least partly derived from the cursor itself and/or its position relative to the object) without the user needing to move the mouse itself. The translation (drag) may be terminated once the object has been translated to the desired position in the GUI display by repositioning the cursor away from the object (by moving the mouse). As a further option, the path for translation might be altered during the drag operation by repositioning the cursor in relation to the object (whilst maintaining their co-location), by moving the mouse. This example demonstrates how the method of the invention can enable more ergonomic mouse operation in order to help reduce the risk of RSI—in this case, drag and drop operation comprises a user positioning a cursor at an object, the object then being automatically translated (dragged) to a desired position and then dropped by the user positioning the cursor away from the object. Further examples can be readily identified by the skilled person.

In accordance with a further aspect of the present invention there is provided an apparatus arranged to generate a GUI display and supporting user-directed movement of objects in the GUI display, the apparatus comprising:
a) a user-operated pointing device operable to output position data;
b) an input port operable to receive position data from the user-operated pointing device;
c) a display; and
d) a data processing unit comprising a CPU and storage for program and data; the input port, display and data processing unit being interconnected by a data bus; the data processing unit being operable:
   I. to render a GUI on the display;
   II. to render a cursor icon within the GUI display; which cursor icon comprises a navigation object and a pointing object;
   III. to read and decode the position data;
   IV. to position the pointing object of the cursor icon in dependence on the position data; and
   V. to translate the cursor icon along a path within the GUI display in dependence on the positioning of the pointing object relative to the navigation object.

The method of the invention may also be applied to a composite object within a GUI display, the composite object comprising both the first object and second object discussed above. An example of a composite object is a cursor icon. This object is intended to emulate various functions normally invoked by actuators of a user input device.

By way of example, a cursor icon devised to emulate functions of a mouse will now be discussed. The icon may be displayed on the GUI display in place of the standard mouse cursor, either permanently, or when the mouse cursor is over a context sensitive region, or in any other suitable circumstance. The icon may comprise two types of active region (objects), a neutral region which corresponds to the mouse functioning as a basic pointing device and one or more selection regions (objects) each of which may emulate a pre-defined function corresponding to an actuation of an actuator (e.g. pressing a mouse button, turning a scroll wheel, etc.); such a function might be recognisable by a context sensitive area of a GUI application. The neutral region might contain a navigation object and a location object, which location object signifies the present location of the icon with respect to the GUI display. A selection region might also contain a navigation object, for example selection region ‘left button down’ might include a navigation object to enable dragging. In addition, a pointing object may be included within the cursor icon. Using the mouse, a user may be able to position the pointing object over any region of the icon and also co-locate the pointing object with a navigation object (which for a 2D GUI display might suitably be circular).

To generally navigate the cursor icon around the GUI display area, a user may co-locate the pointing object with the navigation object located within the neutral region, using the method of the invention described earlier. To drag an application object (i.e. an object not comprised within the cursor icon), a user may navigate the cursor icon so as to situate it over the object (as indicated by the location object); then the user may position the pointing object to be over selection region ‘left button down’ of the icon thereby selecting the application object; then the user may navigate the icon using the navigation object located within region ‘left button down’; once the icon is positioned over the object ‘drop’ position, the user may then position the pointing object back over the neutral region of the icon, thereby ‘releasing’ the left button and dropping the object. It is to be noted that the positioning of the pointing object may preferably be constrained to be within the cursor icon.

An advantage of a composite object such as a cursor icon is that interaction between the objects (e.g. co-location) can be confined within the composite object. This has the benefit of ensuring the predictability of the various interactions since these are defined for, and confined to, the composite object; the results of interaction may, as required, be communicated to an application or operating system external to the composite object using for example, but not limited to, an application programming interface (API) suitable to the application or operating system. An advantage of the cursor icon is that it allows a user to navigate the entire GUI display area by navigating the smaller area of the cursor icon. In addition to the benefits of translation described earlier, in order to navigate the entire GUI display the risk of RSI may be further reduced by the more limited hand travel needed to manipulate the pointing object within the cursor icon compared to the hand travel required when using a mouse in conventional fashion.

Further features and advantages will now be described, by way of example only, with reference to the accompanying drawings in which:

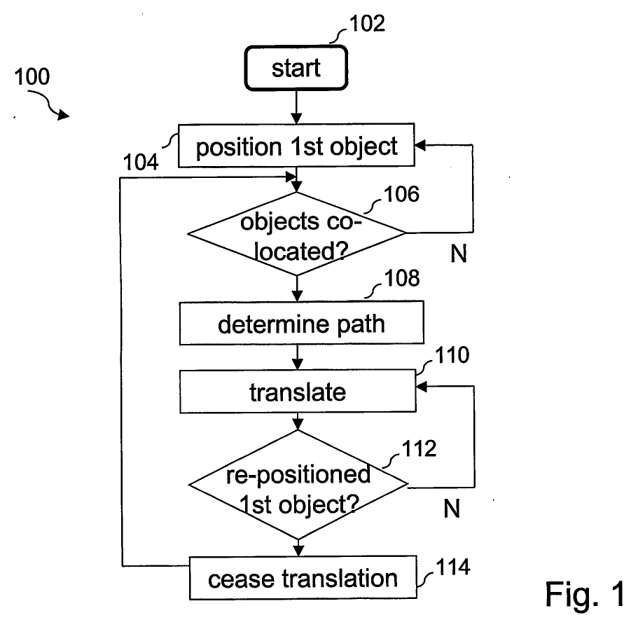

FIG. 1 is a flow diagram of a method embodying one aspect of the invention;

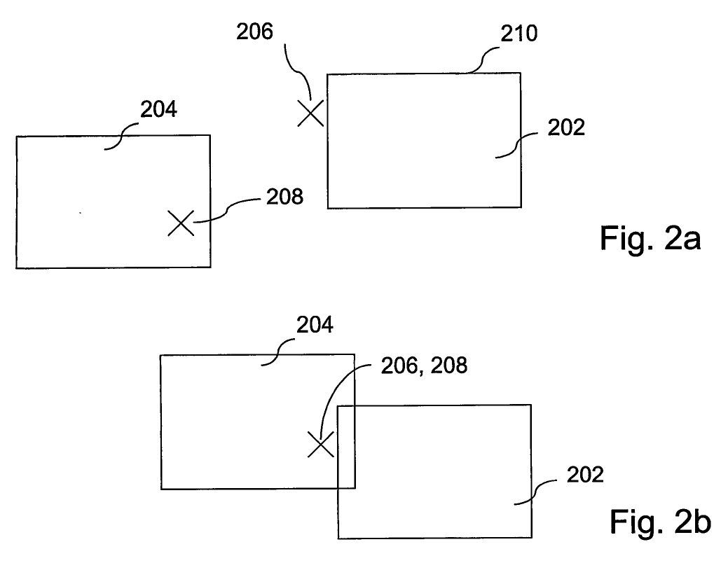

FIG. 2 is a schematic representation showing a first example of the co-location of objects within the GUI display;

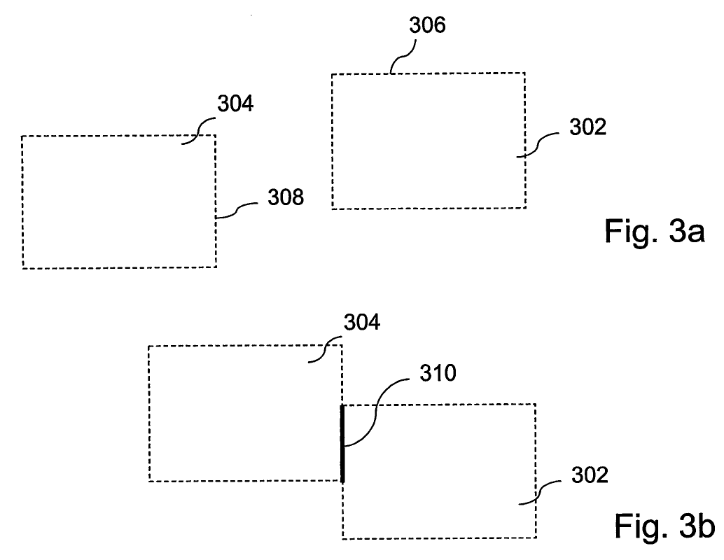

FIG. 3 is a schematic representation showing a second example of the co-location of objects within the GUI display;

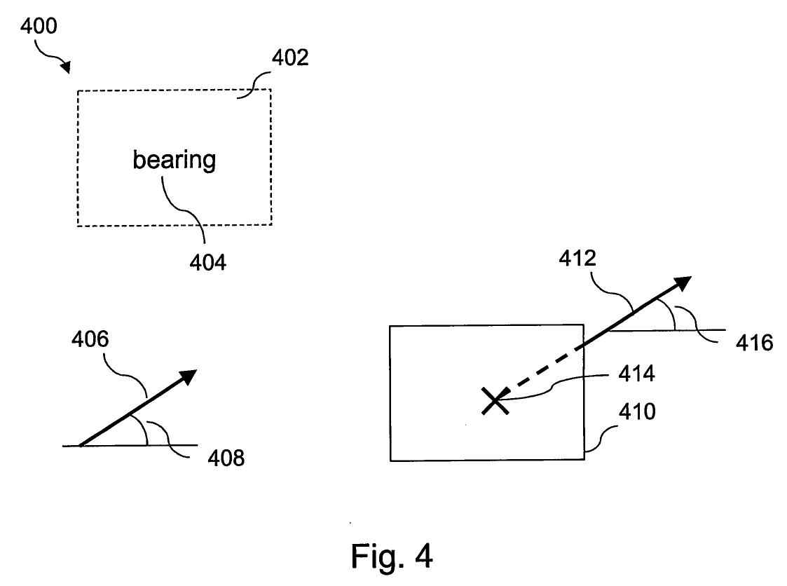

FIG. 4 is a schematic representation showing examples of objects comprising path data applied to the translation of an object;

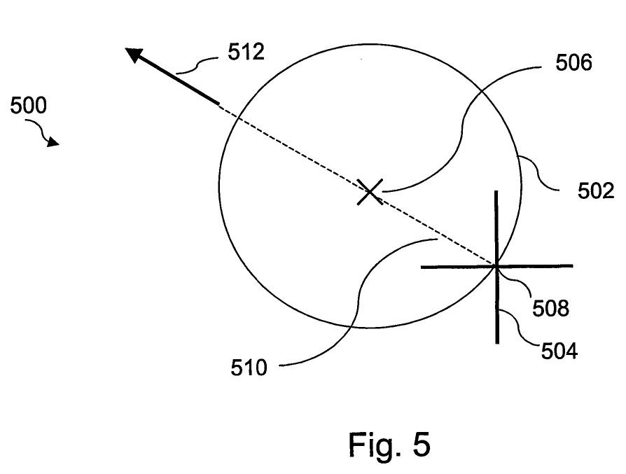

FIG. 5 is a schematic representation showing an example of a path for translation derived from the co-location of objects;

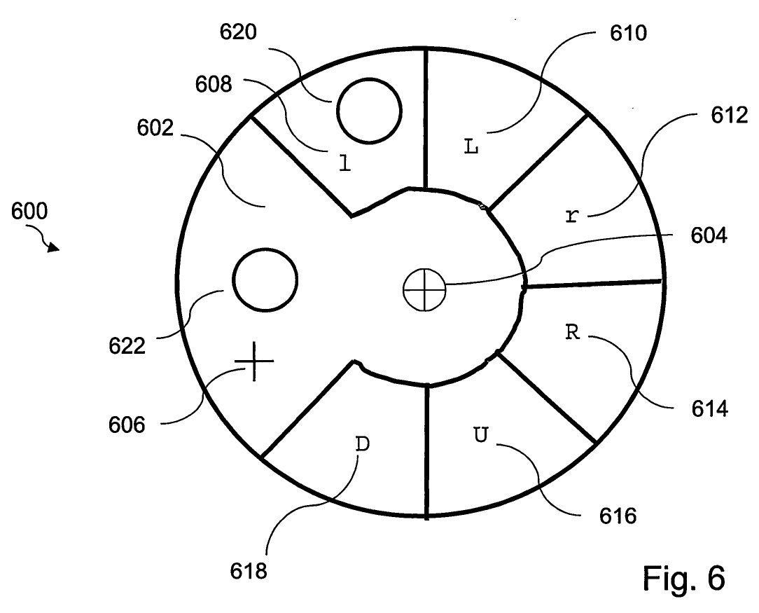

FIG. 6 is a schematic representation showing an example of a cursor icon embodying the invention.

In the following description, the term ‘GUI’ refers to a graphical user interface used in computers and other software driven apparatuses including, but not limited to, TVs, set top boxes, phones, PDAs, etc. The term ‘GUI display’ is used as a general term describing the display of objects with which a user may interact to control the functioning of a software application.

FIG. 1 is a flow diagram of a method embodying one aspect of the invention. The method, shown generally at 100, may for example be used in conjunction with a GUI display comprising at least two objects. The method commences at 102. Within the GUI display a first object is positioned 104 relative to a second object until a co-location of the first object with the second object is detected at 106. Co-location may be detected by a comparison of the relative positions of a pre-defined co-ordinate position associated with the first object and a pre-defined co-ordinate position associated with the second object, as is further discussed below in relation to FIGS. 2 and 3. Once co-location has been detected a path for translation is then determined 108 and the first and second objects are translated 110 according to the determined path. Determination of the path for translation may be according to techniques described below in relation to FIGS. 4 and 5. Translation of the objects continues until the first object is re-positioned 112 relative to the second object, at which point translation ceases 114. The method then loops back to check if the objects are still co-located 106, in which case translation of the objects may once more occur but along a different determined path.

FIG. 2 is a schematic representation showing a first example of the co-location of objects within a GUI display. The figure comprises two parts, wherein FIG. 2a shows a first object 202 not co-located with a second object 204 and FIG. 2b shows the two objects co-located. The first object 202 has an associated pre-defined co-ordinate position 206 and the second object 204 has an associated pre-defined co-ordinate position 208. It is to be noted that an associated pre-defined co-ordinate position is a position relative to a reference co-ordinate position (for example the origin) of the object (as distinct to being relative to the co-ordinate scheme of the GUI display); an associated pre-defined co-ordinate position may be within, on, or outside the outermost boundary of an object to which it relates, for example the associated pre-defined co-ordinate position 206 is shown located outside the outermost boundary 210 of first object 202. In order to co-locate the objects, the first object is positioned in relation to the second object such that their respective associated pre-defined co-ordinate positions 206, 208 are located substantially at the same co-ordinate position relative to the GUI display. The precision in positioning the objects to achieve co-location may be definable to suit the preference or ability of a user. For example, an associated pre-defined co-ordinate position of an object might have a definable zone (not shown in FIG. 2) coupled with the co-ordinate position, which zone comprises a plurality of co-ordinate positions effectively enlarging the size (area) of the original associated pre-defined co-ordinate position thereby reducing the positional accuracy required when co-locating objects. Preferably such a zone would be emanate radially from the relevant co-ordinate position (e.g. circular in a 2D GUI display).

FIG. 3 is a schematic representation showing a second example of the co-location of objects within the GUI display. The figure comprises two parts, wherein FIG. 3a shows a first object 302 not co-located with a second object 304 and FIG. 3b shows the objects co-located. The first object has pre-defined co-ordinate positions 306 which positions correspond to the boundary of the object; similarly the second object has pre-defined co-ordinate positions 308 which positions correspond to the boundary of the object. It is to be noted that a boundary of an object may be any boundary related to an object; that is, not only the boundary corresponding to the visibly outermost boundary of an object. In order to co-locate the objects, the first object 302 is positioned in relation to the second object 304 such that one or more of pre-defined co-ordinate positions 306 is substantially at the same co-ordinate position or positions 310 as one or more of pre-defined co-ordinate positions 308, thereby establishing co-location of the objects. As was noted in the discussion related to FIG. 2, positional precision of the objects to achieve co-location may be defined; in the example shown in the figure, the positional accuracy required would appear to be high in that the boundaries of the objects abut. In practice, achieving co-location by abutting objects is often preferred since this can be readily detected in software; furthermore, when the objects first abut the software may be arranged to stop further positioning of the first object towards the second object to prevent the objects overlapping even though the user may not be capable to perform such positional accuracy. This feature provides an additional means to reduce the object positioning accuracy burden of the user. Co-location by abutting objects is particularly appropriate where one of the objects is a cursor, since this may facilitate a path for translation to be determined from the relative positioning of the objects, as is further discussed in relation to FIG. 5 below.

FIG. 4 is a schematic representation showing examples of objects comprising path data applied to the translation of an object. Two objects 402, 406, shown generally at 400, comprise path data. One object 402 comprises data representing bearing information, for example in the case of a 2D GUI display the bearing information might comprise an angle value relative to the vertical axis of the GUI display; also bearing information includes direction indication for translation along the path. Similarly, two angle values suitably corresponding to orthogonal planes might be provided for a 3D GUI display. An alternative object 406 is depicted wherein the orientation of the object, or a visible component thereof, is used to derive path data for translation. In the general case, the object or visible component might be any symbol comprising an elongate element which may be orientated at an angle relative to an axis of the GUI display, which angle may be used to determine the path for translation. In the depicted example, object 406 is shown as an arrow symbol for a 2D display with angle 408 showing the orientation of the object relative to the horizontal axis of the GUI display. Alternatively, for a 3D display, angle 408 would show the orientation of the object relative to the horizontal plane of the GUI display. In use, the user may first orientate object 406 before co-locating it with the object to be translated. An additional benefit of using a polarised elongate symbol such as an arrow is that the symbol also imparts a direction indication for the translation, similar to the bearing method discussed above. Where a non-polarised elongate symbol is used, direction indication for translation may be derived by other suitable means, such as pre-defined rules. For example, the ‘angle of approach’ used when positioning one object to co-locate with another object might be used to infer a direction. Either object (402 or 406) could be positioned to be co-located with another object 410 in order to translate that object 410. For example, in response to object 406 being co-located with object 410, a path 412 for the translation of object 410 is shown. The angle 416 (relative to the horizontal axis of the GUI display) of the path for translation of object 410 corresponds with the angle 408 of object 406. The direction for translation is inferred from the direction of the arrow symbol of object 406. To finally determine the path for translation, a reference co-ordinate 414 of object 410 is used (which reference co-ordinate is in relation to the GUI display) such that the reference co-ordinate lies on the path for translation. Examples of suitable reference co-ordinates of the object include, but are not limited to, a pre-defined origin or the Windows® GUI origin.

FIG. 5 is a schematic representation showing an example of a path for translation derived from the co-location of objects. The arrangement, shown generally at 500, comprises a first object which is a ‘cross-hair’ cursor 504 which has one associated pre-defined co-ordinate position 508. The cursor is at a position such that it is co-located with a second object 502 by the abutment of co-ordinate position 508 and an associated pre-defined co-ordinate position of the second object (not shown in FIG. 5) located on the boundary of the second object. Unlike the examples given in FIG. 4, cursor 504 does not itself comprise data useable to determine the path for translation. However, the path of translation can alternatively be derived from the relative position of co-located objects. In the depicted example the path of translation may be determined from the relative position of co-located objects (504, 502), the path being a line on which lie a reference co-ordinate 506 of the second object and co-ordinate position 508. The direction for translation along the path may be determined using pre-determined rules. In the example shown, the direction is determined by applying a rule that the direction for translation (represented by 512) corresponds to the cursor 504 appearing to ‘push’ object 502.

FIG. 6 is a schematic representation showing an example of a cursor icon embodying the invention. The cursor icon is shown generally at 600 and is an example of an icon for a two button mouse with scroll wheel. In use, it is intended that the cursor icon substitutes, at least for some operations, conventional mouse functionality, such as to generally navigate a cursor around the GUI display or to drag-and-drop objects. The cursor icon preferably acts as an enhancement to an operating system and/or software applications running on a computer or similar apparatus which utilise a GUI display; software associated with the cursor icon being implemented using a plug-in, an application programmer interface (API) or similar means. In the example of FIG. 6, the cursor icon comprises a cross-hair style cursor 606 which is positionable by a user operating a suitable pointing device including, but not limited to, a mouse, joystick, keypad, tablet or touchscreen. The cursor is operable to be navigated by the user to any region of the cursor icon; two types of regions are shown: a neutral region 602 and several selection regions (608, 610, 612, 614, 616, 618). The neutral region 602 is used to generally navigate the cursor icon around the GUI display; the neutral region comprises a location object 604 which indicates the present co-ordinate position of the cursor icon within the GUI display and a navigation object 622. The navigation object is preferably circular and comprises a plurality of associated pre-defined co-ordinate positions (for clarity, not shown in FIG. 6) distributed on its visibly outermost boundary. The cursor 606 also comprises an associated pre-defined co-ordinate position located at the crosspoint of the cross-hair (for clarity, not shown in FIG. 6). The user may attempt to position the cursor at or over the boundary of navigation object 622 to co-locate the cursor with the navigation object; preferably software associated with the cursor icon might arrange for the associated pre-defined co-ordinate positions of the objects to abut (as per the example of FIG. 5 discussed earlier). When the cursor and navigation object are co-located, software associated with the cursor icon determines the path for translation of the navigation object 622, for example as described in relation to the example of FIG. 5. Translation is then performed; for the purpose of translation, the entire cursor icon and all objects it contains are associated with the navigation object such that the cursor icon as a whole is translated; during translation the relative position of the cursor 606 and navigation object 622 remains the same. It is to be noted that no action (that is, user operation of the pointing device) is required during the translation of the cursor icon. Translation is terminated by the user operating the pointing device so as to alter the relative positioning of the cursor 606 and navigation object 622; however, should the objects still be co-located then a new path for translation will be determined and translation of the cursor icon along the new path will be initiated.

The selection regions of the depicted example cursor icon represent the various actuators found on a 2-button scroll wheel mouse; namely ‘left button down’ 608, ‘left double click’ 610, ‘right button down’ 612, ‘right double click’ 614, ‘scroll up’ 616 and ‘scroll down’ 618. By suitably moving the cursor 606 from the neutral region 602 to a selection region a user may invoke a mouse actuation corresponding to the respective region. For example, moving the cursor 606 from neutral region 602 to selection region 616 will invoke the ‘scroll up’ actuation. Software associated with the cursor icon may arrange to emulate a sequence of ‘scroll up’ actuations by generating appropriate data as if these were actually generated by a user operating a mouse scroll wheel; the software would then communicate this data to the relevant software application or to the operating system running on the host system. As an example, using the cursor 606 and navigation object 622 as described earlier, the user navigates (by means of one or more translations) the cursor icon to be over (as indicated by the location object 604) an object on the GUI display. The user then moves the cursor 606 from neutral region 602 to selection region 608 to invoke the ‘left button down’ actuation. This operation selects the object on the GUI display. Then, by positioning the cursor 606 to be co-located with the navigation object 620 (situated within the ‘left button down’ selection region 608), the user can navigate the cursor icon to ‘drag’ the selected object around the GUI display. Once the desired location in the GUI display has been reached (as indicated by the location object 604, following one or more successive translations), the user may ‘drop’ the selected object by positioning the cursor 606 from selection region 608 back into the neutral region 602 of the cursor icon, thereby effectively invoking actuation ‘left button up’. In this example, utilising the method of the invention a user may ‘drag-and-drop’ an object within a GUI display using a pointing device, the dragging process itself not requiring any user operation of the pointing device. It is to be noted that preferably, positioning of the cursor 606 is restricted to the regions of the cursor icon; in this way, hand travel of the user may be reduced whilst still enabling the user to fully navigate the entire GUI display.

The foregoing method and implementations are presented by way of example only and represent a selection of a range of methods and implementations that can readily be identified by a person skilled in the art to exploit the advantages of the present invention.

In the description above and with reference to FIG. 1 there is disclosed a method for translating an object within a GUI display. Another object, such as a cursor, is positioned 104 so as to be co-located 106 with the object; the object and cursor are then translated 110 along a path at least partially determined 108 by data associated with the cursor. Translation along the path ceases 114 when the relative position of the cursor and object changes 112; translation may continue along a different path if the cursor and object remain co-located. An example embodiment is a cursor icon which allows a user, by manipulating a pointing device, to navigate an entire GUI display area by navigating the smaller area of the cursor icon.

1. A method of translating an object within a GUI display, the display comprising a first object and a second object, the method comprising the steps of:
a) positioning (104) the first object relative to the second object, such that a first pre-defined coordinate position associated with the first object is substantially co-located (106) with a second pre-defined coordinate position associated with the second object:
b) determining (108) a path for translation;
c) translating (110) the first object and the second object according to the determined path, such that the first object remains substantially co-located with the second object during the translation;
d) repositioning (112) the first object relative to the second object; and
e) ceasing (114) the translation.

2. A method as claimed in claim 1, wherein a plurality of pre-defined coordinate positions are associated with the second object, which coordinate positions comprise a boundary of the second object.

3. A method as claimed in claim 2, wherein the boundary encompasses a context sensitive area of the second object.

4. A method as claimed in claim 1, wherein the second object is one of a plurality of objects, which objects are associated such that they are translated as a single object.

5. A method as claimed in claim 1, wherein the first object comprises data, which data is at least partly used to determine the path for translation.

6. A method as claimed in claim 1, wherein the first object comprises an orientatable graphical symbol, the orientation of which is at least partly used to determine the path for translation.

7. A method as claimed in claim 1, wherein a pre-defined rule is at least partly used to determine the path for translation.

8. A method as claimed in claim 1, wherein the path for translation is determined to be a line comprising a reference coordinate of the second object and the second pre-defined coordinate position associated with the second object.

9. A method as claimed in claim 1, wherein the path for translation includes a reference coordinate of the second object.

10. A method as claimed in any of claims 8 to 9, wherein the reference coordinate of the second object is the origin of the second object as defined in accordance with the Windows® GUI.

11. A record carrier comprising software operable to carry out the method of any of the claims 1 to 10.

12. A software utility configured for carrying out the method steps as claimed in any of the claims 1 to 10.

13. A computer apparatus including a data processor, said data processor being directed in its operations by a software utility as claimed in claim 12.

14. An apparatus arranged to generate a GUI display and supporting user-directed movement of objects in the GUI display, the apparatus comprising:
a) a user-operated pointing device operable to output position data;
b) an input port operable to receive position data from the user-operated pointing device;
c) a display; and
d) a data processing unit comprising a CPU and storage for program and data; the input port, display and data processing unit being interconnected by a data bus; the data processing unit being operable:
I. to render a GUI on the display;
II. to render a cursor icon within the GUI display; which cursor icon comprises a navigation object and a pointing object;
III. to read and decode the position data;
IV. to position the pointing object of the cursor icon in dependence on the position data; and
V. to translate the cursor icon along a path within the GUI display in dependence on the positioning of the pointing object relative to the navigation object.

15. An apparatus as claimed in claim 14, in which the cursor icon further comprises:
a location object, operable to indicate the present coordinate position of the cursor icon in relation to the GUI display.

16. An apparatus as claimed in claim 15, in which the cursor icon further comprises:
at least one selection object, which object is operable to emulate a pre-defined function recognisable by a context sensitive area of a GUI application;
wherein, when the cursor icon is positioned over the context sensitive area as indicated by the location object, the pointing object is operable to be positioned over the selection object to invoke the pre-defined function.

17. A method of translating an object within a GUI display substantially as hereinbefore described and with reference to the accompanying drawings.

18. An apparatus arranged to generate a GUI display and supporting user-directed movement of objects in the GUI display substantially as hereinbefore described and with reference to the accompanying drawings.
